(19) United States
(12) Patent Application Publication
(10) Pub. No.: US 2010/0207595 A1
(43) Pub. Date: Aug. 19, 2010

(54) OUTPUT BUFFER CIRCUIT

(76) Inventor: Yutaka Sato, Chiba-shi (JP)

Correspondence Address: Brinks Hofer Gilson & Lione/Seiko Instruments Inc., P.O. Box 10395, Chicago, IL, 60611, US

(21) Appl. No.: 12/707,182

(22) Filed: Feb. 17, 2010

(30) Foreign Application Priority Data
Feb. 19, 2009 (JP) JP2009-036227

(51) Int. Cl. G05F 1/10

(52) U.S. Cl. 323/283

(57) ABSTRACT

Provided is an output buffer circuit capable of reducing output noise, and increasing a response speed. In a case where an output voltage changes from a ground voltage to an inversion voltage of NOR, and a case where the output voltage changes from a power supply voltage to an inversion voltage of NAND, both of two MOS transistors control the output voltage, and hence, a slew rate of the output voltage becomes steep. Thus, a response speed of the output buffer circuit becomes high. Further, in such a case where the output voltage changes in the vicinity of a voltage (VDD/2) other than the above-mentioned cases, only one MOS transistor controls the output voltage, and hence, the slew rate of the output voltage becomes gentle. Thus, a response speed of the output buffer circuit becomes low, which reduces output noise.

### RELATED APPLICATIONS

This application claims priority under 35 U.S.C. §119 to Japanese Patent Application No. 2009-036227 filed on Feb. 19, 2009, the entire content of which is hereby incorporated by reference.

### BACKGROUND OF THE INVENTION

1. Field of the Invention

The present invention relates to an output buffer circuit that adjusts a slew rate of an output voltage of an output terminal.

2. Description of the Related Art

Currently, in a semiconductor integrated circuit, an output buffer circuit is used frequently for outputting an output voltage of a certain circuit to an input terminal of a circuit in a subsequent stage with desired characteristics.

The output buffer circuit is required to prevent the circuit in the subsequent stage from operating incorrectly by reducing output noise.

A conventional output buffer circuit is described.

FIG. 8 is a diagram illustrating the conventional output buffer circuit. FIG. 9 is a timing chart illustrating a conventional output voltage.

In the conventional output buffer circuit, output noise is reduced by a gentle slew rate of an output voltage VOUT of a PMOS 81 and an NMOS 82. For this purpose, the conventional output buffer circuit is configured so that the PMOS 81 and the NMOS 82 are driven with a small current by setting the driving ability of inverters 73 and 75 to be low.

Specifically, the inverters 73 and 75 are allowed to have a driving ability lower than that of an ordinary logic circuit or are formed of transistors with a smaller size.

In the conventional output buffer thus configured, when an input voltage VIN becomes high, the output voltage of the inverter 71 becomes low, and the output voltages of the inverters 72 and 74 become high. Then, the output voltages of the inverters 73 and 75 become low. Thus, the PMOS 81 is turned on, the NMOS 82 is turned off, and the output voltage VOUT becomes high.

At this time, because the circuit is designed so that the driving ability of the inverter 73 is low, a driving current from the inverter 73 to a gate of the PMOS 81 is small. Therefore, a change amount of a gate voltage of the PMOS 81 becomes small.

Therefore, a change amount of an output current of the PMOS 81 also becomes small.

More specifically, in the case of using the inverters 73 and 75 with a high driving ability, the slew rate of the output voltage VOUT becomes steep during a period of t10 to t11 as indicated by a dotted line of FIG. 9. On the other hand, by setting the driving ability of the inverters 73 and 75 to be low, the slew rate becomes gentle during a period of t10 to t12 as indicated by a solid line of FIG. 9, and consequently, output noise is reduced.

The same also applies to the time when the input voltage VIN becomes low (see, for example, JP 11-145806 A).

However, in the conventional art, output noise is reduced, but the change amount of the output current of the PMOS 81 is small and the slew rate of the output voltage VOUT becomes gentle. Therefore, a response speed of the output buffer circuit becomes low.

### SUMMARY OF THE INVENTION

The present invention has been made in view of the above-mentioned problem, and an object of the present invention is to provide an output buffer circuit capable of reducing output noise and suppressing a delay of a response speed.

(1) According to a first aspect of the present invention, there is provided an output buffer circuit that adjusts a slew rate of an output voltage of an output terminal, including: a plurality of first transistors that supply a current from a power supply terminal to the output terminal; a plurality of second transistors that supply a current from the output terminal to a ground terminal; and a control circuit that receives an input voltage and controls the plurality of first transistors and the plurality of second transistors so that the plurality of first transistors and the plurality of second transistors output the output voltage, in which the control circuit includes a first logic circuit having a predetermined driving ability or less to drive the plurality of first transistors and the plurality of second transistors, and the control circuit turns on a predetermined number (at least two) of one of the plurality of first transistors and the plurality of second transistors in a case where the output voltage changes in a predetermined range excluding ½ times a power supply voltage, and turns on one of the plurality of first transistors and the plurality of second transistors in a number smaller than the predetermined number in a case where the output voltage changes outside of the predetermined range.

(2) According to a second aspect of the present invention, in the output buffer circuit according to the first aspect of the present invention, the control circuit further includes a second logic circuit having an inversion voltage different from ½ times the power supply voltage, and turns on one of the plurality of first transistors and the plurality of second transistors in a number in accordance with whether or not the output voltage is in the predetermined range or outside of the predetermined range, based on a magnitude relationship between the output voltage and the inversion voltage.

(3) According to a third aspect of the present invention, in the output buffer circuit according to the second aspect of the present invention, the second logic circuit has characteristics that the inversion voltage approaches ½ times the power supply voltage as the power supply voltage becomes low.

(4) According to a fourth aspect of the present invention, in the output buffer circuit according to the first aspect of the present invention, the control circuit further includes a third logic circuit having at least one of a first inversion voltage that is always lower than ½ times the power supply voltage in a power supply voltage fluctuation range in which a fluctuation of the power supply voltage is allowable and a second inversion voltage that is always higher than ½ times the power supply voltage in the power supply voltage fluctuation range, and the control circuit turns on one of the plurality of first transistors and the plurality of second transistors in a number in accordance with whether or not the output voltage is in the predetermined range or outside of the predetermined range, based on at least one of a magnitude relationship between the output voltage and the first inversion voltage and a magnitude relationship between the output voltage and the second inversion voltage.

(5) According to a fifth aspect of the present invention, in the output buffer circuit according to the fourth aspect of the present invention, the third logic circuit has characteristics that the first inversion voltage and the second inversion voltage approach ½ times the power supply voltage as the power supply voltage becomes low.

According to the present invention, in a range including a voltage ½ times a power supply voltage that is likely to generate output noise (in a range out of a predetermined range), the logic circuit having a predetermined driving ability or less is used, and the first transistors or the second transistors in a number smaller than a predetermined number are turned on. Therefore, the slew rate of an output voltage becomes gentle, to thereby reduce output noise.

On the other hand, in a predetermined range excluding a voltage ½ times a power supply voltage having less influence on output noise, even if the logic circuit having a predetermined driving ability or less is used, the first transistors or the second transistors in a predetermined number (at least two) are turned on. This prevents the slew rate of an output voltage from becoming steep to delay the response speed of the output buffer circuit.

### BRIEF DESCRIPTION OF THE DRAWINGS

In the accompanying drawings:

FIG. 1 is a diagram illustrating an output buffer circuit of a first embodiment of the present invention;

FIG. 2 is a graph illustrating an inversion voltage of the output buffer circuit of the first embodiment;

FIG. 3 is a timing chart illustrating an output voltage of the output buffer circuit of the first embodiment;

FIGS. 4A and 4B are timing charts illustrating output voltages in the cases where a power supply voltage is high and low, respectively;

FIG. 5 is a diagram illustrating an output buffer circuit of a second embodiment of the present invention;

FIG. 6 is a diagram illustrating an inversion voltage of the output buffer circuit of the second embodiment;

FIG. 7 is a timing chart illustrating an output voltage of the output buffer circuit of the second embodiment;

FIG. 8 is a diagram illustrating a conventional output buffer circuit; and

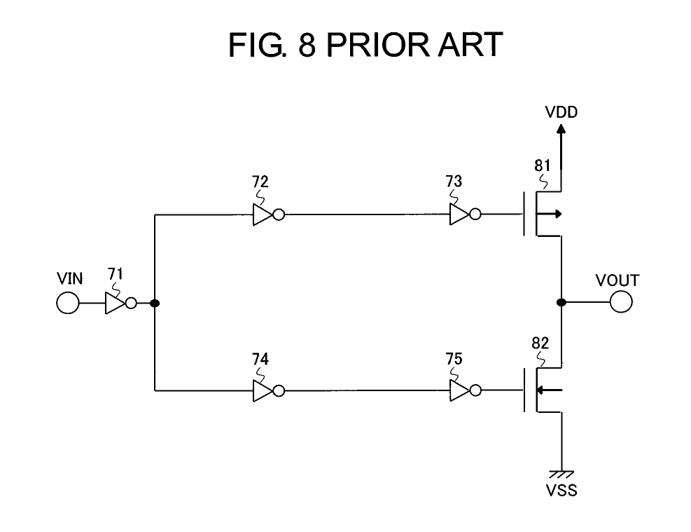

FIG. 9 is a timing chart illustrating a conventional output voltage.

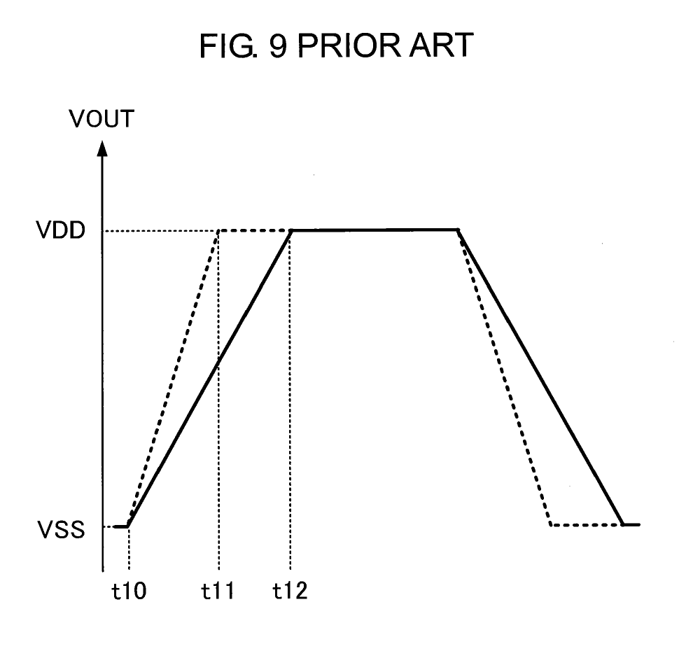

### DETAILED DESCRIPTION OF THE PREFERRED EMBODIMENTS

Hereinafter, the present invention is described by way of embodiments with reference to the drawings.

### (1) Outline of Embodiment

In an output buffer circuit of this embodiment, in the same way as in the conventional art, the driving ability of a logic circuit that drives a transistor in an output stage is designed to be smaller than that of an ordinary logic circuit, to thereby decrease the driving current from the logic circuit to a gate of the transistor in the output stage, and reduce a change amount of a gate voltage of the transistor in the output stage. Thus, a change amount of an output current of the transistor in the output stage is small, and the slew rate of the output voltage of the transistor in the output stage becomes gentle, and hence, output noise is reduced.

On the other hand, when the slew rate of the output voltage of the transistor in the output stage is rendered gentle with respect to the entire range in which the output voltage changes, there arises a problem of a delay of a response speed of the output buffer circuit.

In this embodiment, the fact that the cause of output noise is found in a range close to ½ times a power supply voltage (range out of a predetermined range) is paid attention to, and therefore the slew rate of the output voltage is rendered gentle in the range close to ½ times the power supply voltage, and the slew rate is rendered steep in a predetermined range (range out of the range close to ½ times the power supply voltage).

Specifically, by setting the number of transistors in the output stage that are turned on in the range close to ½ times the power supply voltage to be larger than that of the transistors in the output stage that are turned on in a predetermined range (range out of the range close to ½ times the power supply voltage), the slew rate in the predetermined range is rendered steep to suppress the delay of a response speed.

### (2) Detail of Embodiment

### First Embodiment

First, a configuration of an output buffer circuit is described.

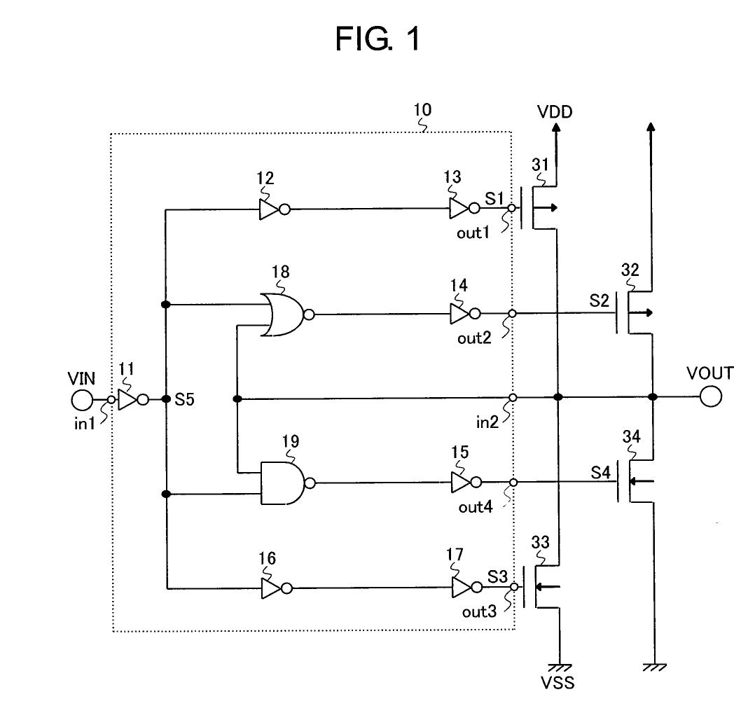

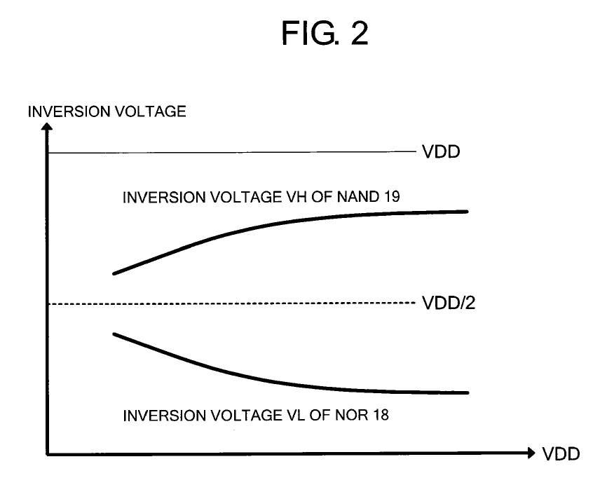

FIG. 1 is a diagram illustrating the output buffer circuit. FIG. 2 is a graph illustrating an inversion voltage.

The output buffer circuit includes a control circuit 10, PMOS transistors (PMOS) 31 and 32 that function as first transistors, and NMOS transistors (NMOS) 33 and 34 that function as second transistors.

The control circuit 10 includes inverters 11 to 17, a NOR 18, and a NAND 19. Further, a voltage input to the output buffer circuit is an input voltage VIN, a voltage output from the output buffer circuit is an output voltage VOUT, output voltages of the inverters 13 and 14, the inverter 17, and the inverter 15 are respectively voltages S1 to S4, and an output voltage of the inverter 11 is a voltage S5.

The inverters 13, 14, 15, and 17 of this embodiment function as a first logic circuit having a predetermined driving ability or less, and the NOR 18 and the NAND 19 function as a second logic circuit having an inversion voltage that is different from ½ times the power supply voltage.

A first input terminal in1 of the control circuit 10 is connected to an input terminal of the output buffer circuit, a second input terminal in2 is connected to an output terminal of the output buffer circuit, a first output terminal out1 is connected to a gate of the PMOS 31, a second output terminal out2 is connected to a gate of the PMOS 32, a third output terminal out3 is connected to a gate of the NMOS 33, and a fourth output terminal out4 is connected to a gate of the NMOS 34. A source of the PMOS 31 is connected to a power supply terminal, and a drain thereof is connected to the output terminal of the output buffer circuit. A source of the PMOS 32 is connected to the power supply terminal, and a drain thereof is connected to the output terminal of the output buffer circuit. A source of the NMOS 33 is connected to a ground terminal, and a drain thereof is connected to the output terminal of the output buffer circuit. A source of the NMOS 34 is connected to the ground terminal, and a drain thereof is connected to the output terminal of the output buffer circuit.

An input terminal of the inverter 11 is connected to the input terminal of the output buffer circuit, and an output terminal thereof is connected to an input terminal of the inverter 12, a first input terminal of the NOR 18, a first input terminal of the NAND 19, and an input terminal of the inverter 16. An input terminal of the inverter 13 is connected to an output terminal of the inverter 12, and an output terminal thereof is connected to the gate of the PMOS 31. An input terminal of the inverter 14 is connected to an output terminal of the NOR 18, and an output terminal thereof is connected to the gate of the PMOS 32. An input terminal of the inverter 17 is connected to an output terminal of the inverter 16, and an output terminal thereof is connected to the gate of the NMOS 33. An input terminal of the inverter 15 is connected to an output terminal of the NAND 19, and an output terminal thereof is connected to the gate of the NMOS 34. The output terminal of the output buffer circuit is connected to second input terminals of the NOR 18 and the NAND 19.

The driving ability of the inverters 13 to 15 and the inverter 17 is lower than that of an ordinary logic circuit. Specifically, the inverters 13 to 15 and the inverter 17 are formed of, for example, transistors with so small size that a current smaller than a predetermined value is output.

As illustrated in FIG. 2, an inversion voltage VL of the NOR 18 has characteristics of being always lower than an inversion voltage (VDD/2) of an ordinary logic circuit in a power supply voltage fluctuation range allowing a fluctuation of a power supply voltage VDD by appropriately adjusting the driving ability of a PMOS (not shown) and an NMOS (not shown) inside the NOR 18 previously. Specifically, the NOR 18 has characteristics that the inversion voltage VL becomes lower than a lowest voltage (VDD/2) caused by a fluctuation of a power supply voltage.

Further, the NOR 18 has characteristics that, when the power supply voltage VDD becomes low, the inversion voltage VL of the NOR 18 becomes high to approach the voltage (VDD/2).

An inversion voltage VH of the NAND 19 has characteristics of being always higher than the inversion voltage (VDD/2) of an ordinary logic circuit in the power supply voltage fluctuation range allowing a fluctuation of the power supply voltage VDD by appropriately adjusting the driving ability of a PMOS (not shown) and an NMOS (not shown) inside the NAND 19 previously. Specifically, the NAND 19 has characteristics that the inversion voltage VH becomes higher than a highest voltage (VDD/2) caused by a fluctuation of a power supply voltage.

Further, the NAND 19 has characteristics that, when the power supply voltage VDD becomes low, the inversion voltage VH of the NAND 19 becomes low to approach the voltage (VDD/2).

Thus, the NOR 18 and the NAND 19 that function as the second logic circuit have characteristics that the inversion voltages VL and VH approach ½ times the power supply voltage, when the power supply voltage becomes low.

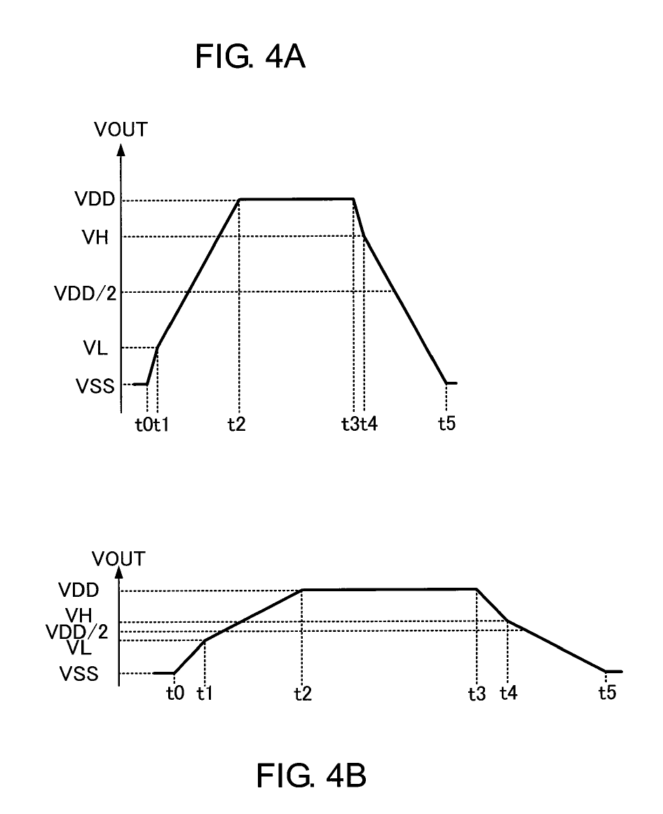

As described later in FIG. 4, in the case where a power supply voltage is low, the range close to ½ power supply voltage (range out of a predetermined voltage) in which the slew rate of the output voltage gentle can be narrowed, and a predetermined range in which the slew rate is rendered steep can be enlarged. As a result, the effect of suppressing the delay of a response speed at a low power supply voltage can be enhanced.

In the case where a power supply voltage is low, the slew rate of an output voltage is gentle. Therefore, even if the range close to ½ power supply voltage is narrowed, the output noise can be reduced effectively.

The PMOS 31 and 32 supply a current from the power supply terminal to the output terminal of the output buffer circuit. The NMOS 33 and 34 supply a current from the output terminal of the output buffer circuit to the ground terminal.

The control circuit 10 receives the input voltage VIN and turns on/off the PMOS 31 and 32 and the NMOS 33 and 34 so that the output voltage VOUT is output.

The control circuit 10 determines whether or not the output voltage VOUT changes in a predetermined range, based on the magnitude relationship between the output voltage VOUT and the inversion voltage VL of the NOR 18 and the inversion voltage VH of the NAND 19. In the case where the output voltage changes in a predetermined range, the control circuit 10 turns on both the PMOS 31 and 32 or both the NMOS 33 and 34, thereby rendering the slew rate of the output voltage VOUT steep.

Further, in the case where the output voltage VOUT changes in the vicinity of the voltage (VDD/2) out of a predetermined range, the control circuit 10 turns on only the PMOS 31 or only the NMOS 33, thereby keeping the slew rate of the output voltage VOUT that is rendered gentle using the inverters 13 and 17 having a predetermined driving ability or less.

Next, an operation of the output buffer circuit is described.

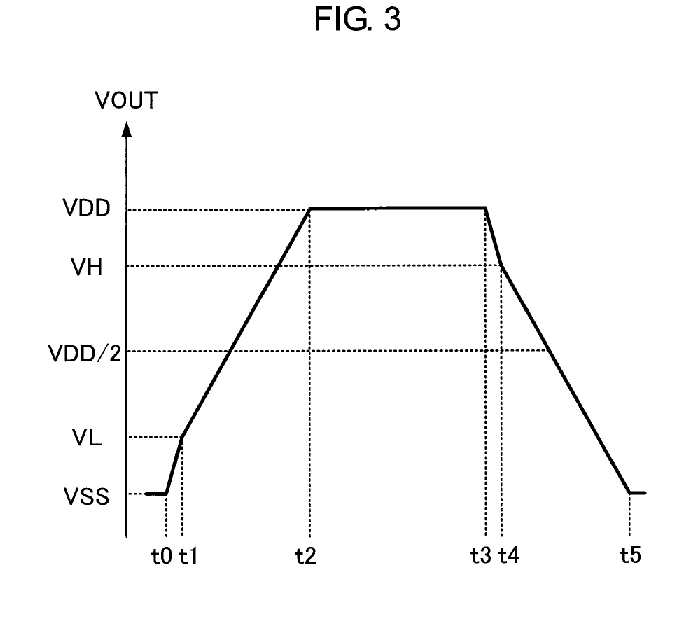

FIG. 3 is a timing chart illustrating an output voltage.

During a period t0 to t1, the input voltage VIN becomes high, and the voltages S1 and S3 become low. Thus, the PMOS 31 is turned on and the NMOS 33 is turned off

Here, because the driving ability of the inverter 13 is designed so as to be lower than that of an ordinary logic circuit, a driving current from the inverter 13 to the gate of the PMOS 31 is small, and a change amount of a gate voltage of the PMOS 31 is small. Thus, a change amount of an output current of the PMOS 31 is small, and the slew rate of the output voltage VOUT controlled by the PMOS 31 becomes gentle, and hence, output noise is reduced. Further, the same applies to the inverter 14 and the PMOS 32, to the inverter 17 and the NMOS 33, and to the inverter 15 and the NMOS 34.

The output voltage VOUT increases from low, but the output voltage VOUT is lower than the inversion voltage VL of the NOR 18. Therefore, the output voltage VOUT is low with respect to the NOR 18 and the NAND 19. Thus, the output voltage VOUT is low and the voltage S5 is also low in the NOR 18, and hence, the voltage S2 also becomes low and the PMOS 32 is turned on. Further, the output voltage VOUT is low in the NAND 19, and hence, the voltage S4 also becomes low and the NMOS 34 is turned off.

Specifically, at this time, both the PMOS 31 and 32 are turned on, and the slew rate of the output voltage VOUT becomes steep. Thus, the output voltage VOUT is controlled by two PMOS, and hence, the response speed of the output buffer circuit becomes high.

During a period of t1 to t2, the output voltage VOUT is higher than the inversion voltage VL of the NOR 18, and hence, the output voltage VOUT is high with respect to the NOR 18. Thus, the output voltage VOUT is high in the NOR 18, and hence, the voltage S2 becomes high and the PMOS 32 is turned off.

Specifically, at this time, the control circuit 10 monitors the output voltage VOUT of the second input terminal in2 and determines whether or not the output voltage VOUT is higher than the inversion voltage VL of the NOR 18. When the output voltage VOUT becomes higher than the inversion voltage VL of the NOR 18, only the PMOS 31 is turned on and the slew rate of the output voltage VOUT becomes gentle. Thus, the output voltage VOUT is controlled by a single PMOS, and hence, the response speed of the output buffer circuit becomes low. Output noise is most expected to occur when the output voltage VOUT changes in the vicinity of the voltage (VDD/2). However, because the response speed of the output buffer circuit becomes low, output noise is reduced.

During a period of t2 to t3, the output voltage VOUT is high during the period in which the input voltage VIN is high.

During a period t3 to t4, the input voltage VIN becomes low, and the voltages S1 and S3 become high. Thus, the PMOS 31 is turned off and the NMOS 33 is turned on.

The output voltage VOUT decreases from high, but the output voltage VOUT is higher than the inversion voltage VH of the NAND 19. Therefore, the output voltage VOUT is high with respect to the NOR 18 and the NAND 19. Thus, the output voltage VOUT is high in the NOR 18, and hence, the voltage S2 also becomes high and the PMOS 32 is turned off. Further, the output voltage VOUT is high and the voltage S5 is also high in the NAND 19, and hence, the voltage S4 also becomes high and the NMOS 34 is turned on.

Specifically, at this time, both the NMOS 33 and 34 are turned on, and the slew rate of the output voltage VOUT becomes steep. Thus, the output voltage VOUT is controlled by two NMOS, and hence, the response speed of the output buffer circuit becomes high.

During a period of t4 to t5, the output voltage VOUT is lower than the inversion voltage VH of the NAND 19, and hence, the output voltage VOUT is low with respect to the NAND 19. Thus, the output voltage VOUT is low in the NAND 19, and hence, the voltage S4 becomes low and the NMOS 34 is turned off.

Specifically, at this time, the control circuit 10 monitors the output voltage VOUT of the second input terminal in2 and determines whether or not the output voltage VOUT is lower than the inversion voltage VH of the NAND 19. When the output voltage VOUT becomes lower than the inversion voltage VH of the NAND 19, only the NMOS 33 is turned on and the slew rate of the output voltage VOUT becomes gentle. Thus, the output voltage VOUT is controlled by a single NMOS, and hence, the response speed of the output buffer circuit becomes low. Output noise is most expected to occur when the output voltage VOUT changes in the vicinity of the voltage (VDD/2). However, because the response speed of the output buffer circuit becomes low, output noise is reduced.

Next, the operation of the output buffer circuit is described by comparison between the case where the power supply voltage VDD is high and the case where the power supply voltage VDD is low.

FIGS. 4A and 4B are timing charts illustrating output voltages in the cases where a power supply voltage is high and low, respectively. FIG. 4A illustrates the case where the power supply voltage is high, and FIG. 4B illustrates the case where the power supply voltage is low.

In the case where the power supply voltage VDD is high, as illustrated in FIG. 4A, a change amount of the entire output current of the PMOS 31 and 32 and the NMOS 33 and 34 becomes large. Therefore, the slew rate of the output voltage VOUT becomes steep as a whole compared with the case where the power supply voltage VDD is low in FIG. 4B. As a result, the response speed of the output buffer becomes high and noise becomes large.

Then, in this embodiment, the period in the vicinity of the voltage (VDD/2) (period out of a predetermined range) where output noise is most expected to occur is prolonged so that the slew rate of the output voltage VOUT may be rendered gentle to reduce output noise.

Specifically, in the case where the power supply voltage VDD is high, the inversion voltage VL of the NOR 18 becomes low (see FIG. 2). Therefore, as illustrated in FIG. 4A, the difference between the inversion voltage VL of the NOR 18 and the voltage (VDD/2) becomes large, the period of t0 to t1 during which the slew rate of the output voltage VOUT is steep in FIG. 3 becomes short, and the period of t1 to t2 during which the slew rate of the output voltage VOUT is gentle becomes long.

Further, the difference between the inversion voltage VH of the NAND 19 and the voltage (VDD/2) becomes large, the period of t3 to t4 in FIG. 3 becomes short, and the period of t4 to t5 becomes long.

In the case where the power supply voltage VDD is low, as illustrated in FIG. 4B, a change amount of the output current of the PMOS 31 and 32 and the NMOS 33 and 34 becomes small. Therefore, the slew rate of the output voltage VOUT becomes gentle as a whole compared with the case where the power supply voltage VDD is high in FIG. 4A, which corresponds to a state where the output noise becomes low and response speed becomes significantly low.

In this case, output noise is small (the slew rate in the vicinity of VDD/2 is gentle). Therefore, the period during which the slew rate of the output voltage VOUT becomes gentle may be shortened in the vicinity of the voltage (VDD/2) where output noise is most expected to occur.

In view of this, in this embodiment, the period in the vicinity of the voltage (VDD/2) where output noise is most expected to occur (range out of a predetermined range) is shortened while the period in a predetermined range where the slew rate of the output voltage VOUT becomes steep is prolonged, to thereby prevent a response speed from becoming remarkably low.

Specifically, in the case where the power supply voltage VDD is low, the inversion voltage VL of the NOR 18 becomes high (see FIG. 2). Therefore, as illustrated in FIG. 4B, the difference between the inversion voltage VL of the NOR 18 and the voltage (VDD/2) becomes small, the period of t0 to t1 during which the slew rate of the output voltage VOUT is steep in FIG. 3 becomes long, and the period of t1 to t2 during which the slew rate of the output voltage VOUT is gentle becomes short. Further, the difference between the inversion voltage VH of the NAND 19 and the voltage (VDD/2) becomes small, the period of t3 to t4 in FIG. 3 becomes long, and the period of t4 to t5 becomes short.

Accordingly, in the case where the output voltage VOUT changes from the ground voltage VSS to the inversion voltage VL of the NOR 18, and in the case where the output voltage VOUT changes from the power supply voltage VDD to the inversion voltage VH of the NAND 19, both two MOS transistors control the output voltage VOUT. Therefore, the slew rate of the output voltage VOUT becomes steep. Thus, a response speed of the output buffer circuit becomes higher.

Further, in the cases other than the above case where the output voltage VOUT changes in the vicinity of the voltage (VDD/2), only one MOS transistor controls the output voltage VOUT. Therefore, the slew rate of the output voltage VOUT becomes gentle. Thus, the response speed of the output buffer circuit becomes low, and hence, output noise is reduced.

In the operation during the period of t0 to t2, the gradient of the slew rate of the output voltage VOUT changes once in FIG. 3. However, the gradient may change a predetermined times although not shown. At this time, a logic circuit and a MOS transistor having an inversion voltage are provided appropriately, and the control circuit 10 controls the MOS transistor as appropriate, based on the inversion voltage and the output voltage VOUT.

### Second Embodiment

Next, a second embodiment is described.

First, the configuration of an output buffer circuit is described.

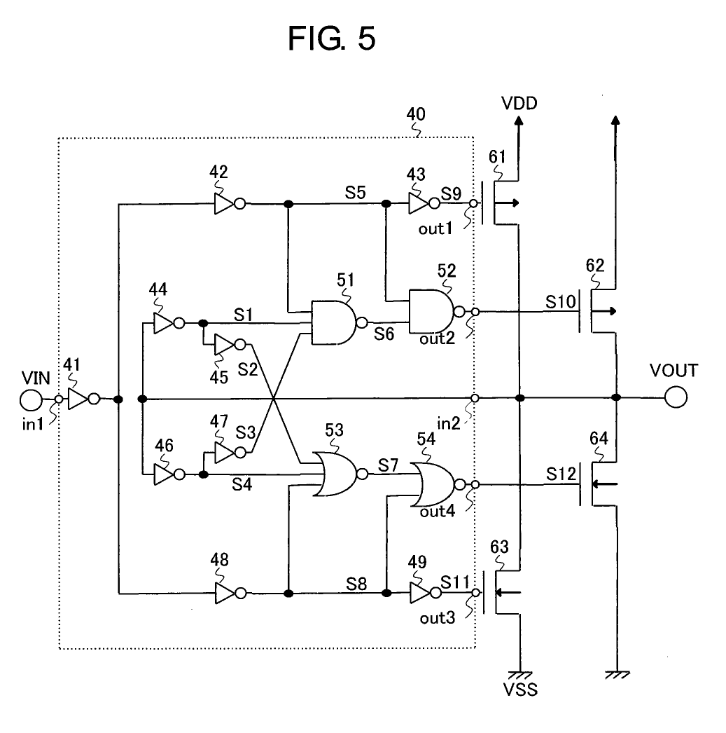

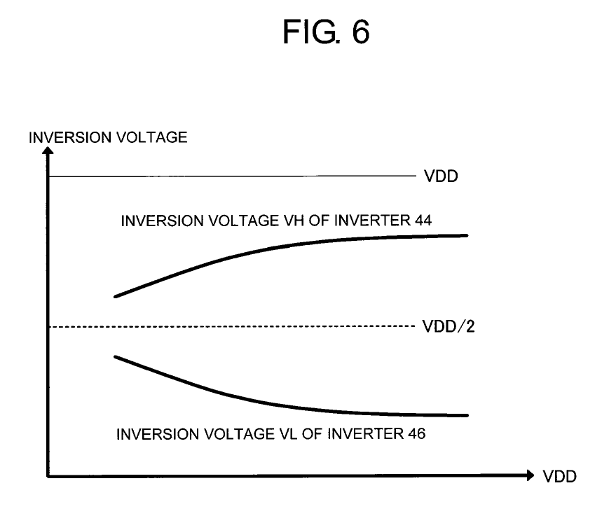

FIG. 5 is a diagram illustrating an output buffer circuit. FIG. 6 is a diagram illustrating an inversion voltage.

The output buffer circuit includes a control circuit 40, PMOS transistors 61 and 62 that function as first transistors, and NMOS transistors 63 and 64 that function as second transistors.

The control circuit 40 has inverters 41 to 49, a NAND 51, a NAND 52, a NOR 53, and a NOR 54. Further, a voltage input to the output buffer circuit is an input voltage VIN, a voltage output from the output buffer circuit is an output voltage VOUT, output voltages of the inverter 43, the NAND 52, the inverter 49, and the NOR 54 are voltages S9 to S12, respectively.

The inverters 44 and 46 of this embodiment function as a third logic circuit.

A first input terminal in1 of the control circuit 40 is connected to an input terminal of the output buffer circuit, a second input terminal in2 is connected to an output terminal of the output buffer circuit, a first output terminal out 1 is connected to a gate of the PMOS 61, a second output terminal out2 is connected to a gate of the PMOS 62, a third output terminal out3 is connected to a gate of the NMOS 63, and a fourth output terminal out4 is connected to a gate of the NMOS 64. A source of the PMOS 61 is connected to a power supply terminal, and a drain thereof is connected to the output terminal of the output buffer circuit. A source of the PMOS 62 is connected to a power supply terminal, and a drain thereof is connected to the output terminal of the output buffer circuit. A source of the NMOS 63 is connected to a ground terminal, and a drain thereof is connected to the output terminal of the output buffer circuit. A source of the NMOS 64 is connected to the ground terminal, and a drain thereof is connected to the output terminal of the output buffer circuit.

An input terminal of the inverter 41 is connected to the input terminal of the output buffer circuit, and an output terminal thereof is connected to input terminals of the inverters 42 and 48. An input terminal of the inverter 43 is connected to an output terminal of the inverter 42, and the output terminal thereof is connected to the gate of the PMOS 61. An input terminal of the inverter 49 is connected to an output terminal of the inverter 48, and the output terminal thereof is connected to the gate of the NMOS 63. A first input terminal of the NAND 51 is connected to the output terminal of the inverter 42, a second input terminal thereof is connected to an output terminal of the inverter 44, a third input terminal thereof is connected to an output terminal of the inverter 47, and the output terminal thereof is connected to a second input terminal of the NAND 52. A first input terminal of the NAND 53 is connected to an output terminal of the inverter 48, a second input terminal thereof is connected to the output terminal of the inverter 46, a third input terminal thereof is connected to an output terminal of the inverter 45, and the output terminal thereof is connected to a second input terminal of the NOR 54. A first input terminal of the NAND 52 is connected to the output terminal of the inverter 42, and the output terminal thereof is connected to the gate of the PMOS 62. A first input terminal of the NOR 54 is connected to the output terminal of the inverter 48, and the output terminal is connected to the gate of the NMOS 64. An input terminal of the inverter 44 is connected to the output terminal of the output buffer circuit, and the output terminal thereof is connected to an input terminal of the inverter 45. An input terminal of the inverter 46 is connected to the output terminal of the output buffer circuit, and the output terminal thereof is connected to an input terminal of the inverter 47.

The driving ability of the inverter 43, the NAND 52, the NOR 54, and the inverter 49 is lower than that of an ordinary logic circuit. Specifically, the inverter 43, the NAND 52, the NOR 54, and the inverter 49 are composed of, for example, transistors with a small size so that a current smaller than a predetermined value is output.

As illustrated in FIG. 6, the inversion voltage VL of the inverter 46 has characteristics similar to those of the inversion voltage VL of the NOR 18 in the first embodiment.

The inversion voltage VH of the inverter 44 has the same characteristics as those of the inversion voltage VH of the NAND 19 in the first embodiment.

Next, an operation of the output buffer circuit is described.

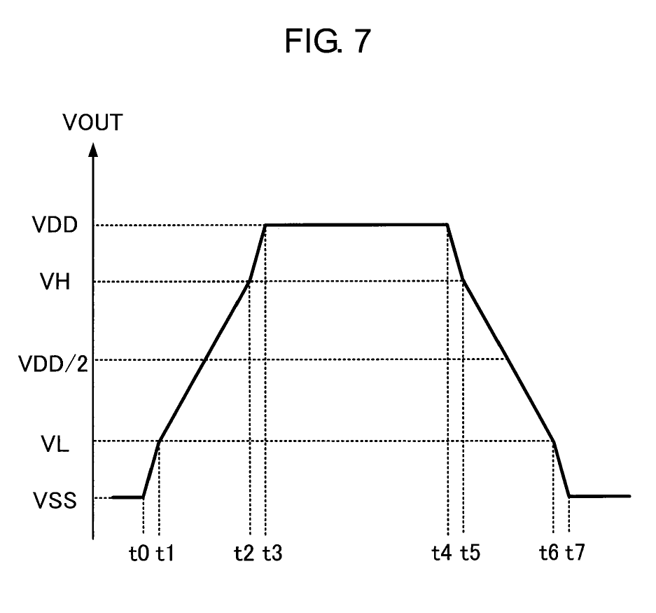

FIG. 7 is a timing chart illustrating an output voltage.

During a period of t0 to t1, the input voltage VIN becomes high, the voltages S5 and S8 becomes high, and the voltages S9 and S11 become low. Thus, the PMOS 61 turns on and the NMOS 63 turns off.

Although the output voltage VOUT increases from low, the output voltage VOUT is lower than the inversion voltage VL of the inverter 46. Therefore, the output voltage VOUT is low with respect to the inverters 44 and 46. Thus, the voltages S1 and S4 become high, and the voltages S2 to S3 become low. Since the voltage S3 is low in the NAND 51, the voltage S6 becomes high, and since the voltages S5 to S6 are high in the NAND 52, the voltage S10 becomes low and the PMOS 62 is turned on. Further, the voltage S4 is high in the NOR 53, and hence, the voltage S7 becomes low. Since the voltage S8 is high in the NOR 54, the voltage S12 becomes low and the NMOS 64 is turned off.

Specifically, at this time, both the PMOS 61 and 62 are turned on, and the slew rate of the output voltage VOUT becomes steep. Thus, two PMOS control the output voltage VOUT.

During a period of t1 to t2, the output voltage VOUT is higher than the inversion voltage VL of the inverter 46, and hence, the output voltage VOUT is high with respect to the inverter 46. Thus, the voltages S1 and S3 become high, and the voltages S2 and S4 become low. Since the voltages S1, S3, and S5 are high in the NAND 51, the voltage S6 becomes low, and since the voltage S6 is low in the NAND 52, the voltage S 10 becomes high and the PMOS 62 is turned off

Specifically, at this time, the control circuit 40 monitors the output voltage VOUT of the second input terminal in2 and determines whether or not the output voltage VOUT is higher than the inversion voltage VL of the inverter 46. When the output voltage VOUT becomes higher than the inversion voltage VL of the inverter 46, only the PMOS 61 is turned on and the slew rate of the output voltage VOUT becomes gentle. Thus, one PMOS controls the output voltage VOUT.

During a period of t2 to t3, the output voltage VOUT is higher than the inversion voltage VH of the inverter 44, and hence, the output voltage VOUT is high with respect to the inverter 44. Thus, the voltages S1 and S4 become low, and the voltages S2 and S3 become high. Since the voltage S1 is low in the NAND 51, the voltage S6 becomes high, and since the voltages S5 and S6 are high in the NAND 52, the voltage S10 becomes low and the PMOS 62 is turned on.

Specifically, at this time, the control circuit 40 monitors the output voltage VOUT of the second input terminal in2 and determines whether or not the output voltage VOUT is higher than the inversion voltage VH of the inverter 44. When the output voltage VOUT becomes higher than the inversion voltage VH of the inverter 44, the PMOS 61 and 62 are both turned on and the slew rate of the output voltage VOUT becomes steep. Thus, two PMOS control the output voltage VOUT.

During a period of t3 to t4, the output voltage VOUT is also high during a period in which the input voltage VIN is high.

During a period of t4 to t5, the input voltage VIN becomes low, the voltages S5 and S8 become low, and the voltages S9 and S11 become high. Thus, the PMOS 61 turns off and the NMOS 63 turns on.

Although the output voltage VOUT decreases from high, the output voltage VOUT is higher than the inversion voltage VH of the inverter 44. Therefore, the output voltage VOUT is high with respect to the inverters 44 and 46. Thus, the voltages S1 and S4 become low, and the voltages S2 and S3 become high. Since the voltage S2 is high in the NOR 53, the voltage S7 becomes low, and since the voltages S7 to S8 are high in the NOR 54, the voltage S12 becomes high and the NMOS 64 is turned on. Further, the voltage S1 is low in the NAND 51, and hence, the voltage S6 becomes high. Since the voltage S5 is low in the NAND 52, the voltage S12 becomes high and the PMOS 62 is turned off.

Specifically, at this time, both the NMOS 63 and 64 are turned on, and the slew rate of the output voltage VOUT becomes steep. Thus, two NMOS control the output voltage VOUT.

During a period of t5 to t6, the output voltage VOUT is lower than the inversion voltage VH of the inverter 44, and hence, the output voltage VOUT is low with respect to the inverter 44. Thus, the voltages S1 and S3 become high, and the voltages S2 and S4 become low. Since the voltages S2, S4, and S8 are low in the NOR 53, the voltage S7 becomes high, and since the voltage S7 is high in the NOR 54, the voltage S12 becomes low and the NMOS 64 is turned off.

Specifically, at this time, the control circuit 40 monitors the output voltage VOUT of the second input terminal in2 and determines whether or not the output voltage VOUT is lower than the inversion voltage VH of the inverter 44. When the output voltage VOUT becomes lower than the inversion voltage VH of the inverter 44, only the NMOS 63 is turned on and the slew rate of the output voltage VOUT becomes gentle. Thus, one NMOS controls the output voltage VOUT.

During a period of t6 to t7, the output voltage VOUT is lower than the inversion voltage VL of the inverter 46, and hence, the output voltage VOUT is low with respect to the inverter 46. Thus, the voltages S1 and S4 become high, and the voltages S2 and S3 become low. Since the voltage S4 is high in the NOR 53, the voltage S7 becomes low, and since the voltages S7 and S8 are low in the NOR 54, the voltage S 12 becomes high and the NMOS 64 is turned on.

Specifically, at this time, the control circuit 40 monitors the output voltage VOUT of the second input terminal in2 and determines whether or not the output voltage VOUT is lower than the inversion voltage VL of the inverter 46. When the output voltage VOUT becomes lower than the inversion voltage VL of the inverter 46, the NMOS 63 and 64 are both turned on and the slew rate of the output voltage VOUT becomes steep. Thus, two NMOS control the output voltage VOUT.

Accordingly, in the case where the output voltage VOUT changes from the ground voltage VSS to the inversion voltage VL of the inverter 46, in the case where the output voltage VOUT changes from the inversion voltage VH of the inverter 44 to the power supply voltage VDD, in the case where the output voltage VOUT changes from the power supply voltage VDD to the inversion voltage VH of the inverter 44, and in the case where the output voltage VOUT changes from the inversion voltage VL of the inverter 46 to the ground voltage VSS, both two MOS transistors control the output voltage VOUT. Therefore, the slew rate of the output voltage VOUT becomes steep. Thus, a response speed of the output buffer circuit becomes higher.

Further, in the cases other than the above case where the output voltage VOUT changes in the vicinity of the voltage (VDD/2), only one MOS transistor controls the output voltage VOUT. Therefore, the slew rate of the output voltage VOUT becomes gentle. Thus, the response speed of the output buffer circuit becomes low, and hence, output noise is reduced.

In the operation during the period of t0 to t3, the gradient of the slew rate of the output voltage VOUT changes twice in FIG. 7. However, the gradient may change a predetermined times although not shown. At this time, a logic circuit and a MOS transistor having an inversion voltage are provided appropriately, and the control circuit 40 controls the MOS transistor as appropriate, based on the inversion voltage and the output voltage VOUT.

What is claimed is:

1. An output buffer circuit that adjusts a slew rate of an output voltage of an output terminal, comprising:
a plurality of first transistors that supply a current from a power supply terminal to the output terminal;
a plurality of second transistors that supply a current from the output terminal to a ground terminal; and
a control circuit that receives an input voltage and controls the plurality of first transistors and the plurality of second transistors so that the plurality of first transistors and the plurality of second transistors output the output voltage,
wherein the control circuit comprises a first logic circuit having a predetermined driving ability or less to drive the plurality of first transistors and the plurality of second transistors, and
wherein the control circuit turns on a predetermined number (at least two) of one of the plurality of first transistors and the plurality of second transistors in a case where the output voltage changes in a predetermined range excluding ½ times a power supply voltage, and turns on one of the plurality of first transistors and the plurality of second transistors in a number smaller than the predetermined number in a case where the output voltage changes outside of the predetermined range.

2. An output buffer circuit according to claim 1, wherein the control circuit further comprises a second logic circuit having an inversion voltage different from ½ times the power supply voltage, and turns on one of the plurality of first transistors and the plurality of second transistors in a number in accordance with whether or not the output voltage is in the predetermined range or outside of the predetermined range, based on a magnitude relationship between the output voltage and the inversion voltage.

3. An output buffer circuit according to claim 2, wherein the second logic circuit has characteristics that the inversion voltage approaches ½ times the power supply voltage as the power supply voltage becomes low.

4. An output buffer circuit according to claim 1,
wherein the control circuit further comprises a third logic circuit having at least one of a first inversion voltage that is always lower than ½ times the power supply voltage in a power supply voltage fluctuation range in which a fluctuation of the power supply voltage is allowable and a second inversion voltage that is always higher than ½ times the power supply voltage in the power supply voltage fluctuation range, and
wherein the control circuit turns on one of the plurality of first transistors and the plurality of second transistors in a number in accordance with whether or not the output voltage is in the predetermined range or outside of the predetermined range, based on at least one of a magnitude relationship between the output voltage and the first inversion voltage and a magnitude relationship between the output voltage and the second inversion voltage.

5. An output buffer circuit according to claim 4, wherein the third logic circuit has characteristics that the first inversion voltage and the second inversion voltage approach ½ times the power supply voltage as the power supply voltage becomes low.
